(19) United States
(12) Patent Application Publication
(10) Pub. No.: US 2008/0021982 A1
(43) Pub. Date: Jan. 24, 2008

(54) DATA COMMUNICATION CHARGING SYSTEM, DATA COMMUNICATION CHARGING METHOD AND COMPUTER-READABLE RECORDING MEDIUM WHICH RECORDS DATA COMMUNICATION CHARGING PROGRAM

(75) Inventor: Takahisa HANNUKI, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Tokyo (JP)

(21) Appl. No.: 11/775,518

(22) Filed: Jul. 10, 2007

(30) Foreign Application Priority Data
Jul. 18, 2006 (JP) 2006-195681

(51) Int. Cl. G06F 15/16

(52) U.S. Cl. 709/219

(57) ABSTRACT

The content fee of a content downloaded from a content service provider (CSP) to a mobile terminal is capable of being confirmed whether it is the content fee of the content actually downloaded to the mobile terminal. A probe device extracts communication data transmitted between the mobile terminal and the CSP. A charging processing server generates charging data for the content downloaded to the mobile terminal based on the packet CDR inputted from a communication control server and on the data inputted from the probe device, and outputs the data to a charging processing server. The charging processing server collates the content fee stated in the charging data with the content CDR provided in advance from the CSP.

### BACKGROUND OF THE INVENTION

1. Field of the Invention

This application is based upon and claims the benefit of priority from Japanese patent application No. 2006-195681, filed on Jul. 18, 2006, the disclosure of which is incorporated herein in its entirety by reference.

The present invention relates to a data communication charging system, a data communication charging method, and a computer-readable recording medium which records a data communication charging program, in which a telecommunications carrier collects the content fee charged for content data downloaded to a mobile terminal on behalf of a content provider who provides the content.

2. Description of Related Art

In a content fee collecting system which has been established conventionally, a telecommunications carrier collects the fees charged for a content downloaded from a content service provider (hereinafter referred to as CSP) to a mobile terminal, from the user of the mobile terminal on behalf of the CSP. Instead, the CPS pays the commission fee of several percentages to the telecommunications carrier. In this system, for the content fee charged by the telecommunications carrier to the user, a content fee stated in a content CDR (Call Detailed Record) transmitted from the application server (hereinafter referred to as AP server) managed on the CSP side is used.

The conventional content fee collecting system mentioned above will be described in detail with reference to FIG. 11. In the conventional content fee collecting system, the telecommunications carrier 6 has a network device 61, a communication control server 62, a charging processing server 63 and a billing processing server 64. The network device 61 detects the number of packets used in data communications carried out by a mobile terminal 80, and outputs identification information for identifying the mobile terminal 80 and the detected number of packets to the communication control server 62.

The communication control server 62 generates a packet CDR including packet use information about the data communications carried out by the mobile terminal 80 based on the identification information and the number of packets inputted, and outputs the data to the charging processing server 63.

The charging processing server 63 calculates the packet fee charged for the data communications of the mobile terminal 80 based on the CDR, generates the charging data for the packet fee, and outputs the data to the billing processing server 64.

Based on the charging data inputted from the charging processing server 63 and the content fee data written in the content CDR transmitted from the AP server 70, the billing processing server 64 sums the packet fee and the content fee charged to the mobile terminal 80 for each predetermined period, and generates billing data indicating the fee charged to the user of the mobile terminal 80 for each predetermined period. Based on the billing data, the billing processing server 64 causes a printer to print out a bill to be sent to the user.

Besides the conventional content fee collecting system realized by the configuration and method described above, an information providing system in which charging is made on information requested by a user (see Japanese Patent Application Laid-Open No. 2002-189943 (Patent Document 1)), and a charging processing device enabling to promote distribution of expensive contents (see Japanese Patent Application Laid-Open No. 2004-302782 (Patent Document 2)) are disclosed.

In the information providing system described in Patent Document 1, a charging server acquires the data amount of a content downloaded to a communication terminal, and based on the data, calculates the communication fee charged for transmitting the content to the user of the communication terminal. Based on the calculated value, charging data to the user is generated.

Further, the charging processing device described in Patent Document 2 includes a unit communication fee table in which the communication fee for a unit amount of data is set to be less expensive as the content fee becomes higher. In the device, a fee calculation unit calculates the communication fee charged for transmitting a content by using the price of the content downloaded to the user terminal device, provided in advance from the content providing server, and by using the data amount supplied in advance from the network device, and a charging processing unit performs charging processing of the communication fee calculated.

However, in the conventional content fee collecting system shown in FIG. 11, the billing processing server 64 sums the packet fee and the content fee based on the charging data inputted from the charging processing server 63 and the content CDR transmitted from the AP server 70 managed by the CSP 7, and generates billing data in which the fee charged to the user is written. This causes a problem that it cannot be confirmed that whether the content fee of the content provided by the CSP 7 is the content fee of the content data actually downloaded to the mobile terminal 80.

Further, in the conventional content fee collecting system, the packet fee required in downloading the content data is so set that the per-packet price is fixed in the same manner as the case of general data transmission. This causes a problem that the packet fee cannot be set flexibly such that the per-packet price of a content frequently used is set lower.

Further, in the information providing system of Patent Document 1, the charging server only calculates the communication fee for transmitting a content to the user of a communication terminal based on the data amount of the content downloaded to the communication terminal, and based on the calculated value, the charging server generates charging data to the user. This system is not a content fee collecting system to collect the content fee of a content downloaded to a communication terminal on behalf of the content provider, so it does not involve a technique to solve the problem caused in the conventional content fee collecting system.

Further, in the charging processing device of Patent Document 2, the fee calculation unit calculates the communication fee for transmitting a content, by using the fee of the content downloaded to a user terminal device provided from the content providing server in advance and the data amount provided from the network device in advance. This causes a problem that it cannot be confirmed whether the content fee of the content transmitted from the content providing server is the content fee of the content actually downloaded to the user terminal device, same as the conventional content fee collecting system shown in FIG. 11. Further, in this charging processing device, a technique to solve the problem that the packet fee cannot be set flexibly is not disclosed.

### SUMMARY OF THE INVENTION

In view of the above, an exemplary object of the present invention is to provide a data communication charging system, a data communication charging method and a computer-readable recording medium which records a data communication charging program, capable of confirming whether a content CDR indicating content data downloaded from the content provider, who provides the content, to a mobile terminal indicates the content data actually downloaded to the mobile terminal.

Another exemplary object of the present invention is to provide a data communication charging system, data communication charging method and a computer-readable recording medium which records a data communication charging program, capable of flexibly setting a packet fee charged for content data downloaded to a mobile terminal.

In order to achieve the objects, as an exemplary aspect of the invention, a data communication charging system according to the present invention includes; a content providing server which transmits content data to a mobile terminal in accordance with a request from the mobile terminal; a charging system server including a charging processing unit which calculates the content fee of the content data and the data communication fee charged for communications with the mobile terminal; and a probe device including a data detail information extracting unit which extracts data detail information from communication data transmitted between the mobile terminal and the content providing server, and a data transmission unit which transmits the extracted data detail information to the charging system server. The charging system server further includes a content detail information authentication unit which receives, from the content providing server, content detail information about the content data transmitted to the mobile terminal, collates the content detail information with the data detail information transmitted from the probe device, and determines whether the content detail information is correct.

According to such a data communication charging system, the content detail information authentication unit of the charging system server collates the information of the content data indicated in the data detail information about the communication data transmitted between the mobile terminal and the content providing server extracted by the probe device, with the content detail information provided in advance from the content providing server. Therefore, it is possible to confirm whether the content detail information about the content data actually downloaded to the mobile terminal is provided from the content providing server, so the telecommunications carrier can charge the correct fee to the user.

As another exemplary aspect of the invention, a data communication charging method according to the present invention includes: a content transmission step in which a content providing server transmits content data to a mobile terminal in accordance with a request from the mobile terminal; a charging processing step in which a charging system server calculates the content fee of the content data and the data communication fee charged for the data amount of communications performed by the mobile terminal. Further, the method also includes, between the content transmission step and the charging processing step: a data detail information extracting step to extract data detail information about communication data transmitted between the mobile terminal and the content providing server; and a content detail information authenticating step to receive, from the content providing server, content detail information about the content data transmitted to the mobile terminal, collate the content detail information with the data detail information, and determine whether the content detail information is correct.

According to such a data communication charging method, information relating to the content data indicated in the data detail information about the communication data transmitted between the mobile terminal and the content providing server and the content detail information provided in advance from the content providing server are collated. Thereby, it is possible to confirm whether the content detail information about the content data actually downloaded to the mobile terminal is provided from the content providing server, so the telecommunications carrier can charge the correct fee to the user.

As still another exemplary aspect of the invention, a data communication charging program according to the present invention is for causing a computer to perform: content charging processing to calculate the content fee of content data when a content providing server transmits the content data to a mobile terminal in accordance with a request from the mobile terminal; communication charging processing to calculate a data communication fee charged for the data amount of communications performed by the mobile terminal; extracted data receiving processing to receive data detail information about communication data transmitted between the mobile terminal and the content providing server, from a probe device which extracts the data detail information; and content detail information authentication processing to receive, from the content providing server, content detail information about the content data transmitted to the mobile terminal, collate the content detail information with the data detail information transmitted from the probe device, and determines whether the content detail information is correct.

According to such a data communication charging program, it is possible to confirm whether the content detail information about the content data actually downloaded to the mobile terminal is provided from the content providing server, so the telecommunications carrier can charge the correct fee to the user.

The present invention is configured as and works as described above. According to the present invention, it is possible to confirm whether the downloaded content data is the data actually downloaded.

### BRIEF DESCRIPTION OF THE DRAWINGS

FIG. 1 is a block diagram showing the overall configuration of an exemplary embodiment according to the present invention;

FIG. 2 illustrates a content information registration DB stored in a storage device constituting the probe device disclosed in the exemplary embodiment shown in FIG. 1;

FIG. 3 illustrates a storage device constituting the charging processing server disclosed in the exemplary embodiment shown in FIG. 1;

FIG. 4A illustrates an example of the content identification list disclosed in FIG. 3, and FIG. 4B illustrates an example of the content unit price list disclosed in FIG. 3;

FIG. 5A illustrates an example of the first per-packet price correction list disclosed in FIG. 3, and FIG. 5B illustrates an example of the second per-packet price correction list disclosed in FIG. 3;

FIG. 6 illustrates a storage device constituting the billing processing server disclosed in the exemplary embodiment shown in FIG. 1;

FIG. 7A illustrates the monthly user charging information registration DB disclosed in FIG. 6, and FIG. 7B illustrates the user management information registration DB disclosed in FIG. 6;

FIG. 8 illustrates the content fee information registration DB disclosed in FIG. 1;

FIG. 9 is a sequence chart showing the overall operation of the exemplary embodiment shown in FIG. 1;

FIG. 10 is a flowchart showing an operation of charging data generation processing of the charging processing server disclosed in the exemplary embodiment shown in FIG. 1; and

FIG. 11 is a block diagram showing the configuration of a conventional content fee collecting system.

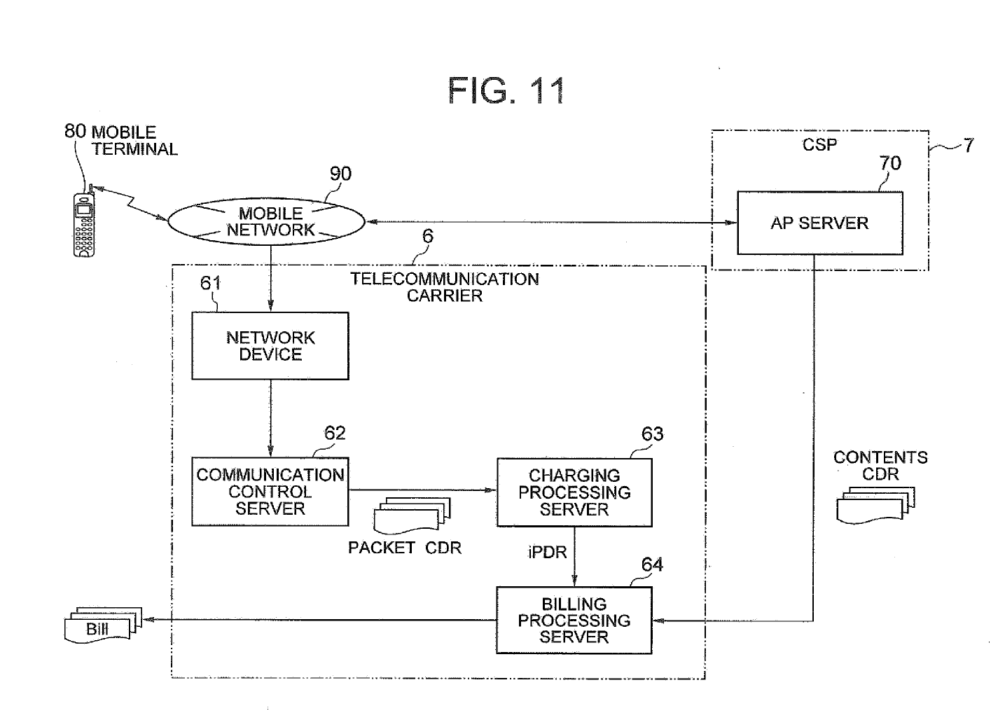

### DESCRIPTION OF EXEMPLARY EMBODIMENT

Hereinafter, an exemplary embodiment of the present invention will be described with reference to the drawings.

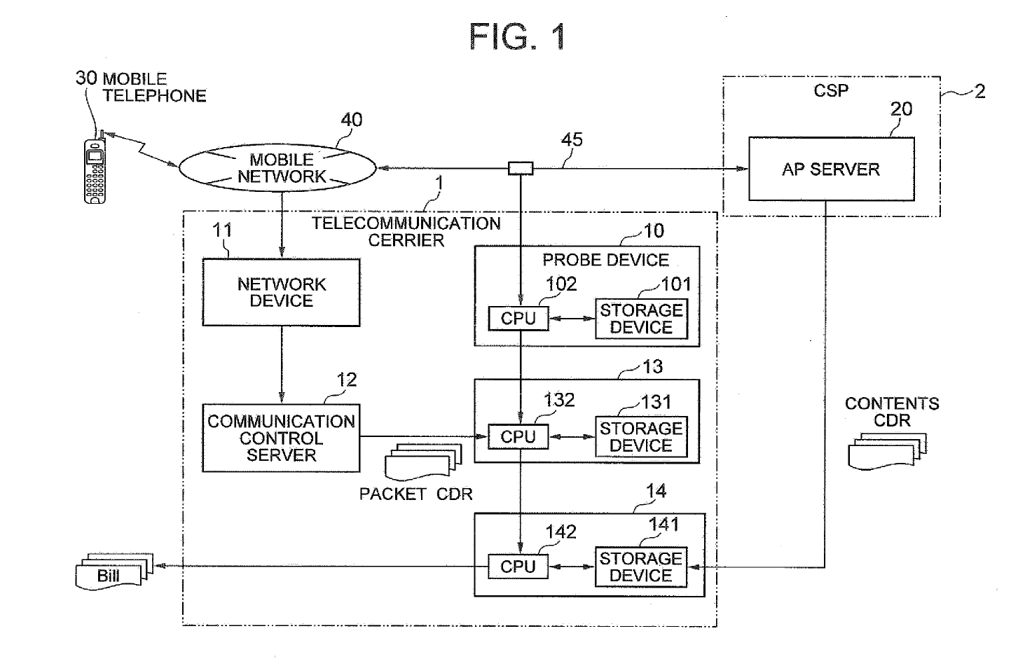

FIG. 1 is a block diagram showing the overall configuration of a data communication charging system according to the present exemplary embodiment.

As shown in FIG. 1, the data communication charging system of the present exemplary embodiment performs charging processing which is caused when content data is downloaded from an application (AP) server 20 serving as a content providing server managed by a content service provider (CSP), to a mobile terminal 30 over a mobile network 40. The system includes a probe device 10 managed by a telecommunications carrier 1, a network device 11, a communication control server 12, a charging processing server 13 and a billing processing server 14.

The probe device 10 shown in FIG. 1 is connected with a communication line 45 which connects the mobile network 40 and the AP server 20 for performing communications between them. The probe device 10 includes a storage device 101 and a CPU 102. The storage device 101 includes a RAM, a ROM and a hard disk, and has a control program (not shown) for causing the CPU 102 to execute various kinds of processing. As communication protocols for transmitting data to the communication line 45, HTTP (Hypertext Transfer Protocol), SMTP (Simple Mail Transfer Protocol), POP (Post Office Protocol), FTP (File Transfer Protocol) and RTSP (Realtime Streaming Protocol) are used, corresponding to the type of content data.

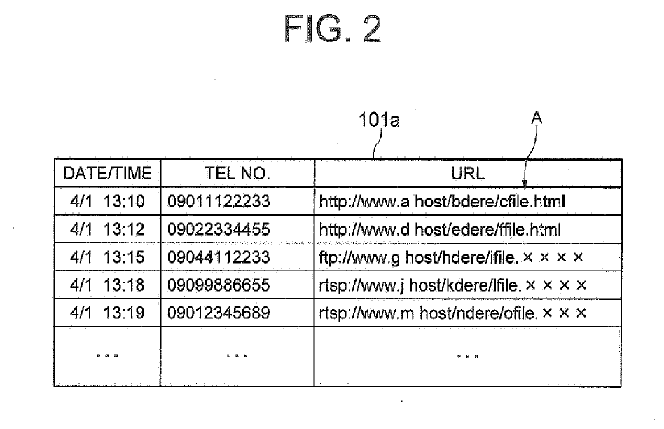

The CPU 102 of the probe device 10 has a function as a data detail information extracting unit to regularly monitor communication data transmitted from the AP server 20 provided to the CSP 2 to the mobile terminal 30, and when detecting that communication data is transmitted from the AP server 20 to the mobile terminal 30, to extract data detail information about the communication data transmitted. The CPU 102 also has a function as a data transmission unit to store information including transmission date and time shown in the data detail information extracted, the telephone number of the mobile terminal 30 and the URL (Uniform Resource Locator) indicating the location where the data is stored, in the communication data information registration DB 101a (FIG. 2), and to output the data to the charging processing server 13.

The network device 11 consists of a gateway device, an exchange device or a combination thereof, and manages data communications in the mobile network 40. Specifically, the network device 11 detects the communication date/time of the mobile terminal 30, the number of packets which indicates the data amount of the communications, and the telephone number allocated to the mobile terminal 30, and outputs the detected date/time, the number of packets and the telephone number to the communication control server 12.

The communication control server 12 generates a packet CDR, which is communication detail information about the communications carried out by the mobile terminal 30, by using information indicating the communication date/time, the number of packets and the telephone number from the network device 11, and outputs the packet CDR to the charging processing server 13. The packet CDR contains the origination number (telephone number of the mobile terminal 30), the receiving side identification information, the data communication date/time, and the number of communication packets.

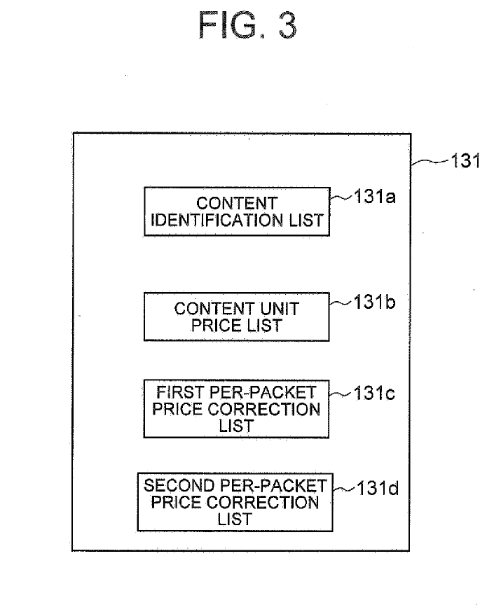

As shown in FIG. 1, the charging processing server 13 includes a storage device 131 and a CPU 132. The storage device 131 includes a RAM, a ROM and a hard disk, and stores a control program (not shown) for causing the CPU 132 to execute various kinds of processing, a content identification list 131a, a content unit price list 131b, a first per-packet price correction list 131c and a second per-packet price correction list 131d, shown in FIG. 3.

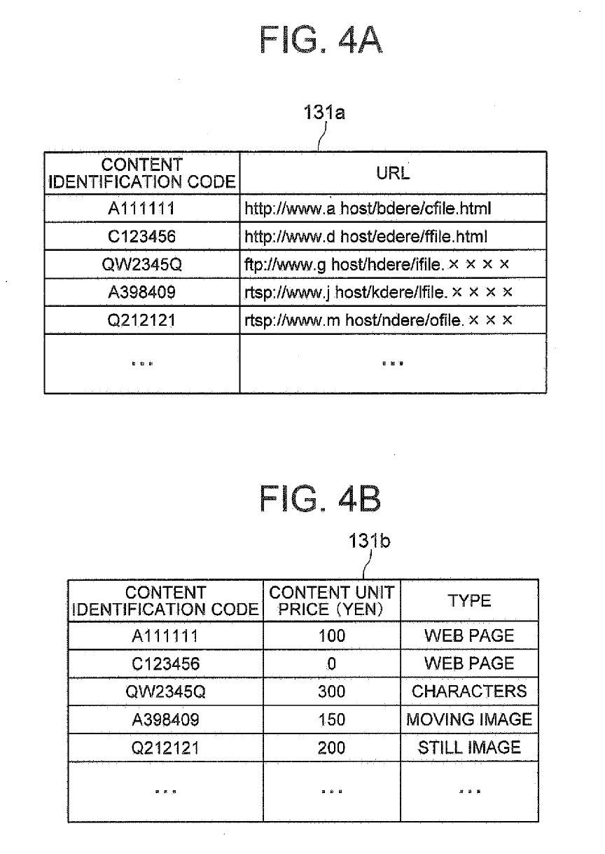

The content identification list 131a shown in FIG. 4A is for identifying content data supplied by the AP server 20, in which the URL corresponding to each content identification code is written.

The content unit price list 131b shown in FIG. 4B is for specifying the unit price and the type of content data, in which the unit price (yen) and type of the content corresponding to each content identification code is written.

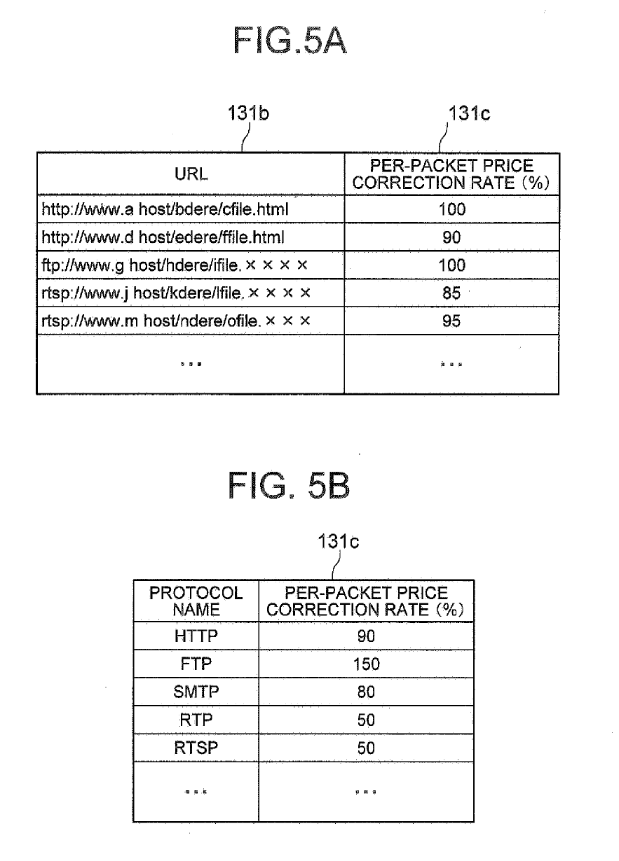

The first per-packet price correction information registration DB 131c shown in FIG. 5A is a list for calculating the packet fee corresponding to an URL designating the location where content data is stored, in which a correction rate to the per-packet price as the base fee corresponding to each URL is written.

The second per-packet price correction information registration DB 131d shown in FIG. 5B is a list for calculating the packet price corresponding to a protocol used when content data is downloaded. This DB indicates a second per-packet price correction rate which is a correction rate to the per-packet price as the base fee corresponding to each protocol used in downloading content data.

The CPU 132 of the charging processing server 13 has a function to refer to the content identification list 131a, the content unit price list 131b, the first per-packet price correction list 131c and the second per-packet price correction list 132d, and based on the data detail information from the probe device 10, to specify the content fee of the content data downloaded from the AP server 20 to the mobile terminal 30, and the per-packet price charged for transmitting the content data.

The CPU 132 collates the packet CDR from the communication control server 12 with the data detail information from the probe device 10, and selects the packet CDR corresponding to the data detail information from the probe device 10, based on the fact that the origination number (telephone number of the mobile terminal 30) and the data communication date/time are same. The CPU 132 has a function as a charging processing unit to calculate the packet fee charged for transmitting the content data, according to the number of packets shown in the selected packet CDR and the per-packet price charged for transmitting the content data specified based on the data from the probe device 10.

Based on the content fee and the packet fee calculated in this manner, charging data for the content data downloaded to the mobile terminal 30 is generated and outputted to the billing processing server 14.

The charging data includes: a telephone number allocated to the mobile terminal 30 to which the content data is downloaded; date and time that the content data is downloaded to the mobile terminal 30; the type of the content data; the protocol used in transmitting the content data; the number of packets used in transmitting the content data; the packet fee charged for transmitting the content (corrected fee), the content fee; and the total charge in which the packet fee and the content fee are added.

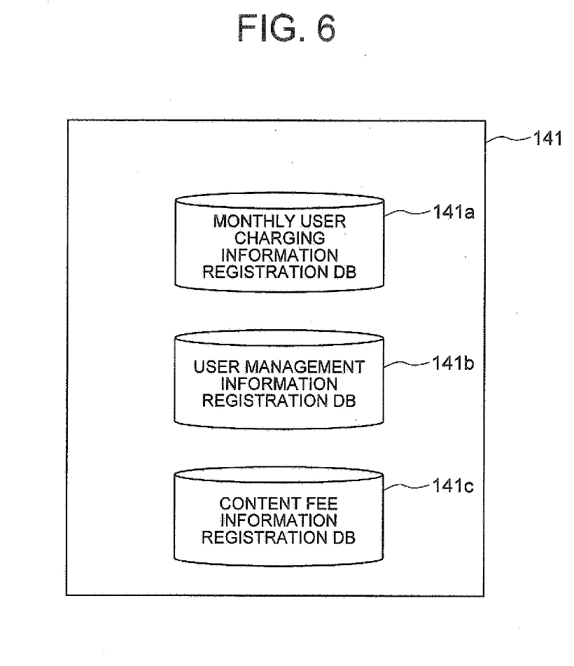

The billing processing server 14 shown in FIG. 1 includes the storage device 141 and the CPU 142. The storage device 141 includes a RAM, a ROM and a hard disk, and stores a control program (not shown) to cause the CPU 142 to execute various kinds of processing, and a monthly user charging information registration DB 141a, a user management information registration DB 141b and a content fee information registration DB 141c, shown in FIG. 6.

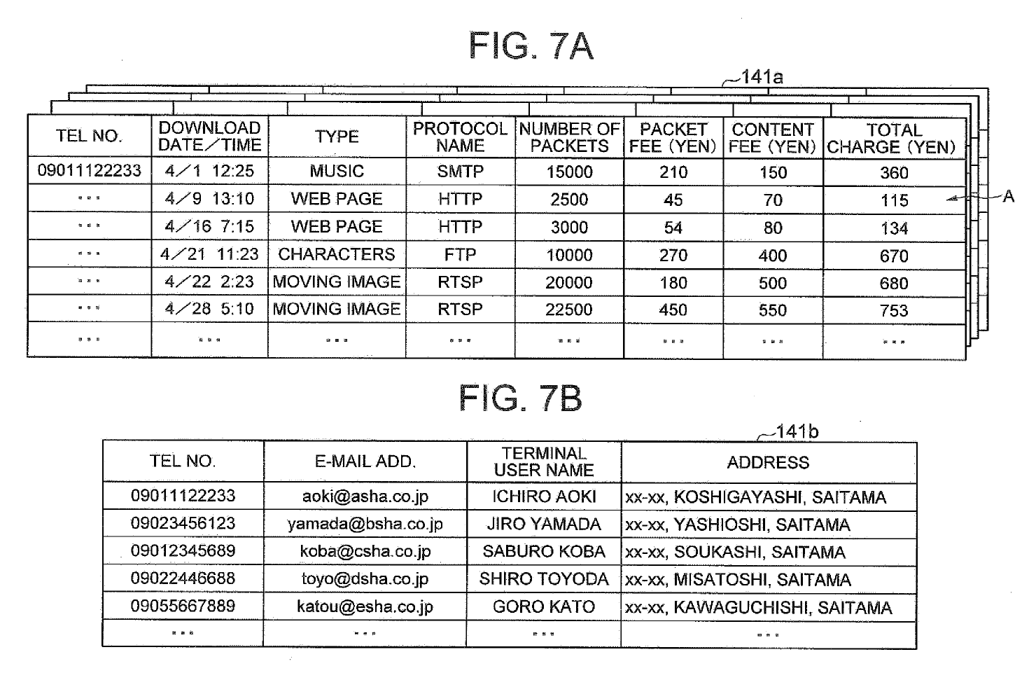

In the monthly user charging information registration DB 141a in the billing processing server 14, a monthly user charging file (FIG. 7A) for each user is registered. The monthly user charging file stores charging data inputted from the charging processing server 13. Namely, the monthly user charging file stores charging data including the telephone number allocated to the mobile terminal 30 of the user, the date/time that the content data is downloaded to the mobile terminal 30, the type of content, the protocol used when the content data is downloaded, the number of packets used for the content data transmitted, the content fee charged for the transmitted content data, and the total charge that the content fee and the packet price are summed.

Further, the user management information registration DB 141b stores user management data required for preparing a bill to be issued to each user. As shown in FIG. 7, the user management data includes a telephone number allocated to the mobile terminal 30 of each user, the e-mail address, and the name and address of the user.

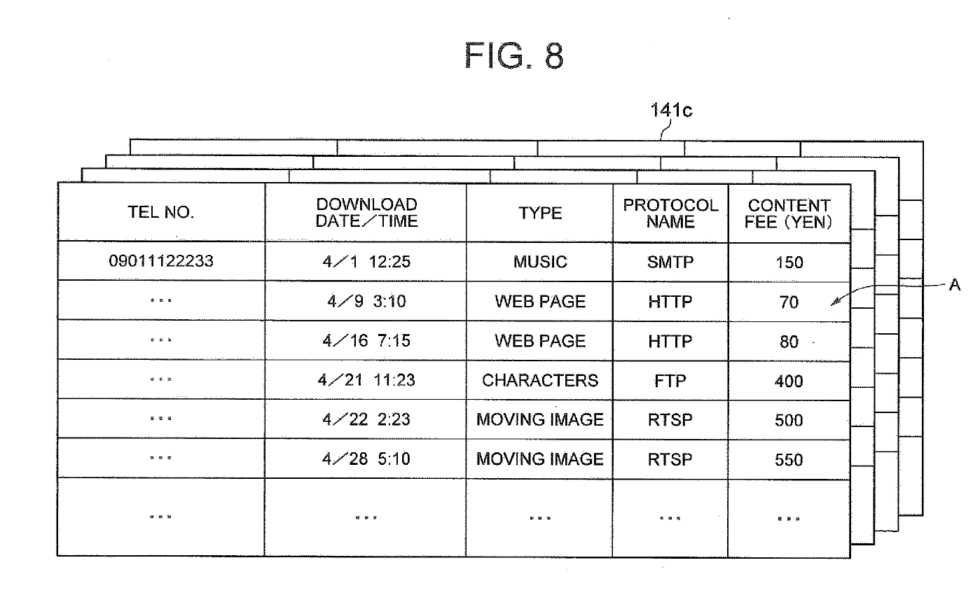

Further, the content fee information registration DB 141c stores a content CDR showing the content fee for each user, which is charged by the CSP 2 to the telecommunications carrier 1. As shown in FIG. 8, the content CDR includes a telephone number allocated to the mobile terminal 30 to which a content is downloaded, date/time that the content is downloaded to the mobile terminal 30, the type of content, the protocol name and the content fee.

The CPU 142 of the billing processing server 14 shown in FIG. 1 has a function of receiving a content CDR from the AP server 20. The content CDR is content detail information of each content data downloaded from the AP server 20 to the mobile terminal 30, including date/time of transmitting the content data, the content identification code, the receiving side identification information (telephone number of the mobile terminal 30), the volume of data, and the content fee. The CPU 142 has a function of writing the content CDR in the content fee information registration DB 141c.

On the date of calculating the communication fee with respect to a mobile terminal 30, the CPU 142 generates bill data for preparing a bill including the communication packet fee of the mobile terminal 30 and the fee for the content provided by the CSP 2, by using the charging data stored in the charging file of the user written in the monthly user charging information registration DB 141a and the user management data stored in the user management information registration DB 141b.

Further, the CPU 142 has a function as a content detail information authentication unit which determines, before or after preparing the bill, whether the content fee that the telecommunications carrier 1 collects on behalf of the CSP 2 and the content fee demanded by the CSP 2 coincide, by collating the charging data stored in the user charging file of the monthly user charging information registration DB 141a and the content CDR transmitted from the CSP 2 stored in the content fee information registration DB 141c.

Next, the overall operation of the data communication charging system according to the present exemplary embodiment will be described. Further, the respective steps of a data communication charging method according to the present invention will be described as well.

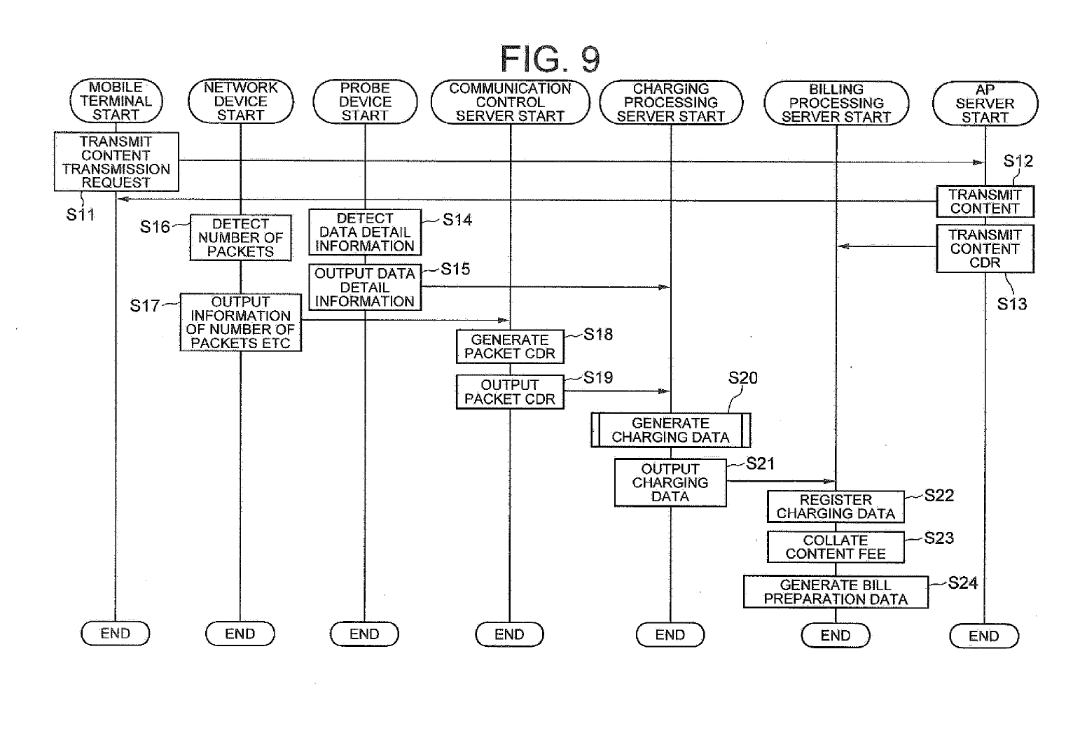

FIG. 9 is a sequence chart showing the overall operation of the data communication charging system according to the present exemplary embodiment.

When a user manipulates the mobile terminal 30 to acquire a content, the mobile terminal 30 transmits a content transmission request to the AP server 20 managed by the CSP 2 over the mobile network 40, by using the CDMA (Code Division on Multiple Access) as the communication system (FIG. 9, step S11).

When the AP server 20 receives the content transmission request from the mobile terminal 30, the AP server 20 transmits the content data designated in the URL of the transmission request to the mobile terminal 30 over the communication line 45 and the mobile network 40 in units of packets of 128K bites for example (FIG. 9, step S12, content transmission step). The content data to be transmitted is accompanied by the download date/time, the destination telephone number (telephone number of the mobile terminal 30), and the above-mentioned URL.

Then, the AP server 20 transmits a content CDR on the transmitted content data to the billing processing server 14 (FIG. 9, step S13).

When the CPU 102 of the probe device 10 detects data detail information from the communication data transmitted from the AP server 20 to the mobile terminal 30 (FIG. 9, step S14), the CPU 102 extracts the data detail information including the transmission date/time, the destination telephone number (telephone number of the mobile terminal 30) and the URL information, accompanying the communication data. Then, the CPU 102 writes the data detail information including the read out date/time, the telephone number, and the URL, into the content information registration DB 101a, and outputs it to the charging processing server 13 (FIG. 9, step S15).

For example, if the date/time is “Apr. 9, 3:10”, the telephone number of the mobile terminal 30 is “09011122233”, and the URL is “http://www.ahost/bdere/cfile.html”, data denoted by A in FIG. 2 is generated, which is written in the content information registration DB 101a and is outputted to the charging processing server 13.

The network device 11 detects the number of packets used in the data communications performed by the mobile terminal 30 (FIG. 9, step 516). Then, the network device 11 outputs information including the date/time of the data communications, the origination telephone number (telephone number allocated to the mobile terminal 30), and the detected number of packets, to the communication control server 12 (FIG. 9, step S17).

When the date/time of the data communications, the telephone number of the mobile terminal and the number of packets used in the data communications are inputted from the network device 11, the communication control server 12 generates a packet CDR (FIG. 9, step S18), and outputs the packet CDR to the charging processing server 13 (FIG. 9, step S19).

When the data is inputted from the probe device 10 (data detail information extracting step) and the packet CDR is inputted from the communication control server 12, the charging processing server 13 performs charging data generation processing from the data and the packet CDR inputted (FIG. 9, step S20, charging processing step). Then, the charging processing server 13 outputs the generated charging data to the billing processing server 14 (FIG. 9, step S21).

When the charging data is inputted from the charging processing server 13, the billing processing server 14 writes the charging data into the corresponding monthly user charging file stored in the monthly user charging information registration DB 141a in the storage device 141 (FIG. 9, step S22).

For example, in the case of charge data in which the telephone number is “09011122233”, the download date/time is “4/9, 13:10”, the type is “Web page”, the protocol name is “HTTP”, the number of packets is “2500”, the per-packet price is “45”, the content fee is “70”, and the total charge is “115”, the data is written in the monthly user charging file as indicated by A in FIG. 7A.

Then, when a time to issue a bill to the user comes, the billing processing server 14 refers to the charge data stored in the monthly user charging file of the user and the content CDR stored in the user content fee file of the user written in the content fee information registration DB 141c to thereby collate the content fees indicated in the respective pieces of data (FIG. 9, step S23, content detail information authenticating step).

For example, if the charge data denoted by A in FIG. 7A and the content CDR denoted by A in FIG. 8 are collated with each other, it is found that the content fee charged by the CSP 2 and the content fee actually downloaded to the mobile terminal 30 are inconsistent.

As a result of collation, if the billing processing server 14 determines that the content fees are different, the billing processing server 14 determines the content fee described in the charging data generated by the charging processing server 13 as the content fee charged to the user on behalf of the CSP 2. Further, the both pieces of data are stored in the storage device 141 as data for notifying the CSP 2 of the fact that the different content fee was charged at a later date.

When the collation of every data is completed, the billing processing server 14 generates bill data for preparing a bill to be issued to the user, by using the user management data stored in the user management information registration DB 141b and the charging data registered in the monthly user charge file of the corresponding user (FIG. 9, step S24). Then, the billing processing server 14 causes a printer (not shown) to print a bill for charging the user by using the generated bill data, and ends the processing.

Note that the charging processing step, the data detail information extracting step and the content detail information authenticating step, described above, may be provided as programs so that the steps are to be executed by a computer controlling the charge processing server 13 or the billing processing server 14, as content charging processing, communication charging processing, extraction data receiving processing and content detail information authentication processing.

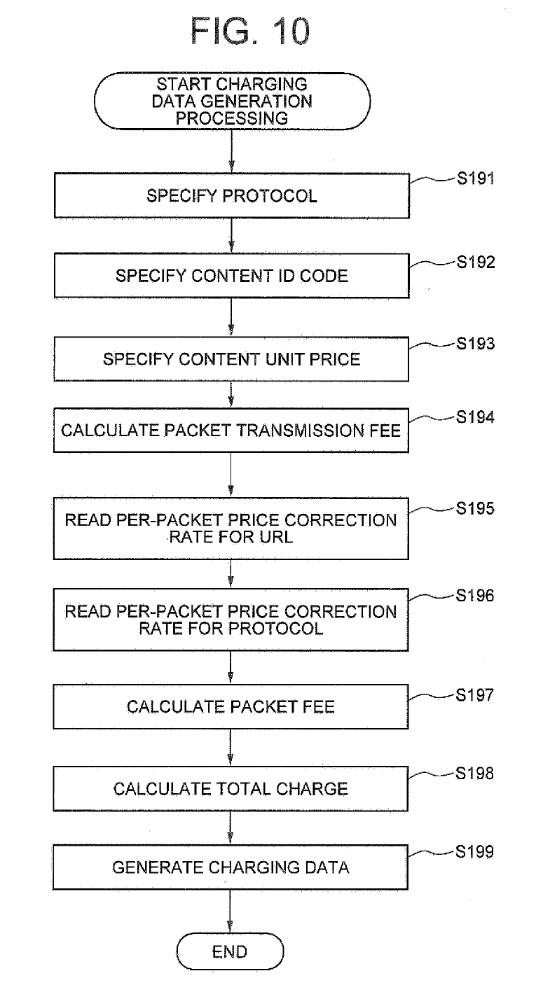

Next, an operation of charging data generation processing of the charging processing server 13 will be described with reference to FIG. 10.

When data detail information is inputted from the probe device 10 and a packet CDR is inputted from the data communication control server 12, the CPU 132 of the charging processing server 13 first refers to the scheme described in the URL shown in the data detail information from the probe device 10 and specifies the protocol used when the content data is transferred (FIG. 10, step S191).

For example, if the URL is

“http://www.ahost/bdere/cfile.html”, the scheme is “http”, so the charging processing server 13 specifies that the protocol used in transferring the content is “HTTP”.

Then, the charging processing server 13 refers to the content identification list 131a (shown in FIG. 4A) stored in the storage device 131 to thereby specify the content identification code for identifying the content data downloaded to the mobile terminal 30 (FIG. 10, step S192).

For example, if the URL indicated in the data detail information from the probe device 10 is

“http://www.ahost/bdere/cfile.html”, it is specified that the content identification code of the content data downloaded is “A111111” as shown in FIG. 4A.

Then, when the charging processing server 13 specifies the content identification code of the content data downloaded, the charging processing server 13 refers to the content unit price list 131b (shown in FIG. 4B) stored in the storage device 131, and specifies the unit price and type of the content with the content identification code (FIG. 10, step S193).

For example, it the specified content identification code is “A111111”, it is specified that the unit price of the content is “100 (yen)” and the type is “web page” as shown in FIG. 4B.

Then, the charging processing server 13 reads out the number of packets written in the packet CDR inputted from the data communication control server 12, and multiplies the number of packets by the unit price for transmitting one packet (per-packet transmission fee) to thereby calculate the packet transmission fee of the downloaded content data.

For example, if the number of packets of the downloaded content data is 2500 packets and the per-packet transmission fee is “0.02 (yen)”, the packet transmission fee of the content is calculated as “50 (yen)”.

When the charging processing server 13 calculates the content fee of the content downloaded to the mobile terminal 30, then the charging processing server 13 refers to the first packet fee correction list 131c (shown in FIG. 5A) stored in the storage device 131 and reads out the per-packet fee correction rate corresponding to the URL specified beforehand (FIG. 10, step S195).

For example, if the URL specified beforehand is “http://www.ahost/bdere/cfile.html”, the per-packet fee correction rate is set to “100(%)” as shown in FIG. 5A.

Then, the charging processing server 13 refers to the second per-packet fee correction list 131d (shown in FIG. 5B) stored in the storage device 131, and reads out the per-packet fee correction rate corresponding to the protocol used in downloading the content to the mobile terminal 30 (FIG. 10, step S196).

For example, if the protocol specified beforehand is “HTTP”, the per-packet fee correction rate is set to “90(%)” as shown in FIG. 5B.

In this manner, when the charging processing server 13 reads out the per-packet fee correction rate for the URL and the per-packet fee correction rate for the protocol, the charging processing server 13 then multiplies the packet fee calculated beforehand by the per-packet fee correction rate for the URL and the per-packet fee correction rate for the protocol to thereby calculate the packet fee charged for the communications to download the content (FIG. 10, step S197).

For example, if the per-packet fee correction rate for the specified URL is “100(%)” and the per-packet fee correction rate for the protocol is “90(%)” and the packet fee calculated beforehand is “50 (yen)”, the packet fee charged to the user is calculated to be “50*1*0.9=45 (yen)”.

Then, the charging processing server 13 adds the content fee of the downloaded content data specified beforehand and the calculated packet fee charged to the user to thereby calculate the total charge (FIG. 10, step S198).

For example, if the content fee specified beforehand is “70 (yen)” and the calculated packet fee charged to the user is “45 (yen)”, the total charge is calculated to be “115 (yen)”.

Then, the charging processing server 13 generates charging data by using the telephone number of the mobile terminal to which the content is downloaded, the date/time that the content is downloaded, the type of the content, the name of the protocol used in downloading the content, the number of packets used in downloading the content, the packet fee, the content fee and the total charge (FIG. 10, step S199).

For example, if the telephone number of the mobile terminal to which the content is downloaded is “09011122233”, the date/time that the content is downloaded is “Apr. 9, 3:10”, the type of content is “Web page”, the name of protocol used in downloading the content is “HTTP”, the number of packets used in downloading the content is “2500”, the packet fee is “45 (yen)”, the content fee is “70 (yen)”, and the total charge is “115 (yen)”, the following charging data is generated: “aoki@asha.co.jp” is written in the e-mail address field, “Apr. 9, 3:10” is written in the download date/time field, “Web page” is written in the content type field, “HTTP” is written in the protocol field, “2500” is written in the packet number field, “45 (yen)” is written in the packet fee field, “70 (yen)” is written in the content fee field, and “115 (yen)” is written in the total charge field.

Although, in the present exemplary embodiment, the charging processing server 13 generates charging data and billing processing server 14 collates the charging data from the charging processing server 13 with a content CDR from the AP server 20 to thereby generate billing data, the present invention is not limited to this exemplary embodiment. A server having the functions of the charging processing server 13 and the billing processing server 14 may be provided as a charging system server, instead of the charging processing server 13 and the billing processing server 14.

According to the exemplary embodiment descried above, the billing processing server 14 collates the content fee charged for the content data indicated in the communication data detected by the probe device 10 with the content CDR provided in advance by the CSP 2. Therefore, it is possible to confirm whether the content fee of the content data presented by the CSP 2 to the billing processing server 14 coincides with the content fee charged for the content data actually downloaded to the mobile terminal 30.

Further, the charging processing server 13 corrects the basic packet fee required in downloading the content data to the mobile terminal 30, based on the first fee correction data for correcting the packet fee according to the URL indicating the storing place of the content data and on the second fee correction data for correcting the packet fee according to the protocol, to thereby calculate the packet fee charged to the user of the mobile terminal 30. Thereby, the packet fee charged for downloading the content data to the mobile terminal 30 can be set flexibly.

Further, the charging processing server 13 generates charging data in which the corrected packet fee and the content fee are summed. Therefore, bill data needed in preparing a bill to be issued to the user can be generated.

Further, the charging processing server 13 detects the URL where the content data is stored and detects the protocol used in downloading the content data to the mobile terminal 30. Therefore, the URL and the protocol required for flexibly setting the packet fee charged in downloading the content data can be acquired.

It is also possible to constitute the exemplary embodiment of the present invention in a following manner. That is, in the data communication charging system, the charging processing unit in the charging system server mentioned above may have a function of calculating the content fee of the content data and the data communication fee charged for transmitting the content data, based on the data detail information transmitted from the probe device.

With this configuration, the fee for the content data actually downloaded to the mobile terminal can be calculated without depending on the data provided from the content providing server.

Further, in the charging system server of the data communication charging system, the charging processing unit may have a function of calculating the data communication fee charged for transmitting the content data, based on the data communication fee for each unit communication data amount set in association with the data detail information transmitted from the probe device.

With this configuration, the basic packet fee which is the data communication fee for each unit communication data amount can be set corresponding to each content of data to be transmitted. Thereby, the data communication fee charged for transmitting content data can be set flexibly.

Further, in the data communication charging system, the data detail information may include identification information of the content providing server, and the charging processing unit may have a function of calculating the data communication fee charged for transmitting the content data, based on the data communication fee for each unit communication data amount set in association with the identification information of the content providing server. With this configuration, the basic packet fee can be set for each source of data, so the data communication fee charged for transmitting content data can be set flexibly.

Further, in the data communication charging system, the data detail information may include information indicating a protocol used in transmitting the content data, and the charging processing unit may have a function of calculating the data communication fee charged for transmitting the content data, based on the data communication fee for each unit communication data amount set in association with the protocol. With this configuration, the basic packet fee can be set for each protocol used in data transmission, so the data communication fee charged for transmitting content data can be set flexibly.

Further, in the data communication charging method, the charging processing step may be so configured as to calculate the content fee of the content data and the data communication fee charged for transmitting the content data, based on the data detail information transmitted from the probe device. With this configuration, the fee for the content data actually downloaded to the mobile terminal can be calculated without depending on the data provided from the content providing server.

Further in the content charging processing in the data communication charging program, the content fee charged for the content data may be calculated based on the data detail information. With this configuration, the fee charged for the content data actually downloaded to the mobile terminal can be calculated without depending on the data provided from the content providing server.

Further, in the communication charging processing in the data communication charging program, the data communication fee for transmitting content data may be calculated based on the data communication fee for each unit communication data amount set in association with the data detail information. With this configuration, the data communication fee charged for transmitting the content data can be set flexibly.

The invention may be embodied in other specific forms without departing from the spirit or essential characteristic thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A data communication charging system, comprising:
a content providing server which transmits content data to a mobile terminal in accordance with a request from the mobile terminal;
a charging system server including a charging processing unit for calculating a content fee of the content data and a data communication fee charged for communications with the mobile terminal; and
a probe device including a data detail information extracting unit for extracting data detail information from communication data transmitted between the mobile terminal and the content providing server, and a data transmission unit for transmitting the extracted data detail information to the charging system server, wherein
the charging system server further includes a content detail information authentication unit for receiving, from the content providing server, content detail information about the content data transmitted to the mobile terminal, collating the content detail information with the data detail information transmitted from the probe device, and determining whether the content detail information is correct.

2. The data communication charging system, according to claim 1, wherein
the charging processing unit in the charging system server has a function of calculating the content fee of the content data and the data communication fee charged for transmitting the content data, based on the data detail information transmitted from the probe device.

3. The data communication charging system, according to claim 1, wherein
in the charging system server, the charging processing unit has a function of calculating the data communication fee charged for transmitting the content data, based on a data communication fee for each unit communication data amount set in association with the data detail information transmitted from the probe device.

4. The data communication charging system, according to claim 1, wherein
the data detail information includes identification information of the content providing server, and
the charging processing unit has a function of calculating the data communication fee charged for transmitting the content data, based on a data communication fee for each unit communication data amount set in association with the identification information of the content providing server.

5. The data communication charging system, according to claim 1, wherein
the data detail information includes information indicating a protocol used in transmitting the content data, and
the charging processing unit has a function of calculating the data communication fee charged for transmitting the content data, based on a data communication fee for each unit communication data amount set in association with the protocol.

6. A data communication charging system, comprising:
a content providing server which transmits content data to a mobile terminal in accordance with a request from the mobile terminal;
a charging system server including a charging processing means for calculating a content fee of the content data and a data communication fee charged for communications with the mobile terminal; and
a probe device including a data detail information extracting means for extracting data detail information from communication data transmitted between the mobile terminal and the content providing server, and a data transmission means for transmitting the extracted data detail information to the charging system server, wherein
the charging system server further includes a content detail information authentication means for receiving, from the content providing server, content detail information about the content data transmitted to the mobile terminal, collating the content detail information with the data detail information transmitted from the probe device, and determining whether the content detail information is correct.

7. A data communication charging method, comprising:
a content providing server transmitting content data to a mobile terminal in accordance with a request from the mobile terminal; and
a charging system server calculating a content fee of the content data and a data communication fee charged for a data amount of communications performed by the mobile terminal, further comprising:
extracting data detail information about communication data transmitted between the mobile terminal and the content providing server;
receiving, from the content providing server, content detail information about the content data transmitted to the mobile terminal; and
collating the content detail information with the data detail information to determine whether the content detail information is correct.

8. The data communication charging method, according to claim 7, comprising:
the charging system server for calculating the content fee of the content data and the data communication fee charged for transmitting the content data, based on the data detail information.

9. A computer-readable recording medium which records a data communication charging program, wherein the program causes a computer to perform:
calculating a content fee of content data when a content providing server transmits the content data to a mobile terminal in accordance with a request from the mobile terminal;
calculating a data communication fee charged for a data amount of data communications performed by the mobile terminal;
receiving data detail information about communication data transmitted between the mobile terminal and the content providing server, from a probe device which extracts the data detail information;
receiving, from the content providing server, content detail information about the content data transmitted to the mobile terminal; and
collating the content detail information with the data detail information transmitted from the probe device to determine whether the content detail information is correct.

10. The computer-readable recording medium which records the data communication charging program, according to claim 9, wherein the program is so defined as to calculate the content fee of the content data based on the data detail information in the calculation of the content fee.

11. The computer-readable recording medium which records the data communication charging program, according to claim 9, wherein the program is so defined as to calculate the data communication fee based on a data communication fee for each unit communication data amount set in association with the data detail information in the calculation of the data communication fee.

12. The probe device, used in combination with the charging system server for calculating the content fee of content data transmitted to the mobile terminal from the content providing server and the data communication fee of communications performed by the mobile terminal, comprising:
a data detail information extracting unit for extracting data detail information from communication data transmitted between the mobile terminal and the content providing server; and
a data transmission unit for transmitting the extracted data detail information to the charging system server.

13. The probe device, used in combination with the charging system server for calculating the content fee of content data transmitted to the mobile terminal from the content providing server and the data communication fee of communications performed by the mobile terminal, comprising:
a data detail information extracting means for extracting data detail information from communication data transmitted between the mobile terminal and the content providing server; and
a data transmission means for transmitting the extracted data detail information to the charging system server.

14. The charging system server, used in combination with the probe device for extracting data detail information from communication data transmitted between the content providing server and the mobile terminal, comprising:
a content detail information authentication unit for receiving, from the content providing server, content detail information about the content data transmitted to the mobile terminal, collating the content detail information with the data detail information transmitted from the probe device, and determining whether the content detail information is correct.

15. The charging system server, used in combination with the probe device for extracting data detail information from communication data transmitted between the content providing server and the mobile terminal, comprising:
a content detail information authentication means for receiving, from the content providing server, content detail information about the content data transmitted to the mobile terminal, collating the content detail information with the data detail information transmitted from the probe device, and determining whether the content detail information is correct.
